(19) United States
(12) Patent Application Publication
(10) Pub. No.: US 2026/0064746 A1
(43) Pub. Date: Mar. 5, 2026

(54) Multimodal Data Ingestion And Retrieval For Agent Systems

(71) Applicant: Oracle International Corporation, Redwood Shores, CA (US)

(72) Inventors: Xin Zhang, Seattle, WA (US); Zheng Wang, Sammamish, WA (US); Yuying Wang, Lexington, KY (US); Genyi Huang, Boston, MA (US); Mengqing Guo, Redmond, WA (US); Yazhe Hu, Bellevue, WA (US); Zhonghai Deng, Redmond, WA (US); Yimo Liu, Seattle, WA (US); Rongguang Wang, Seattle, WA (US); Tao Sheng, Bellevue, WA (US)

(73) Assignee: Oracle International Corporation, Redwood Shores, CA (US)

(21) Appl. No.: 19/082,451

(22) Filed: Mar. 18, 2025

Related U.S. Application Data
(60) Provisional application No. 63/691,178, filed on Sep. 5, 2024.
(60) Provisional application No. 63/691,172, filed on Sep. 5, 2024.

(51) Int. Cl. G06F 16/31; G06F 16/334; G06V 30/413

(52) U.S. Cl. CPC G06F 16/31; G06F 16/3344; G06F 16/3347; G06V 30/413

(57) ABSTRACT

Techniques for multimodal document retrieval are disclosed herein. Multimodal documents that include both textual and graphical components are retrieved from a knowledge base by a multimodal retrieval augmented generation (RAG) agent in response to a query. The documents and/or components or chunks thereof are retrievable by the RAG agent from the knowledge base using the semantic summaries and/or vector search of embeddings in the knowledge base that are generated from text extracted from processing non-textual components of the data. The RAG agent classifies the query type to determine whether to use a semantic match for text or image summaries, full text semantic search, vector cosine similarity search, and/or other multimodal vector search. The RAG agent performs types of searches selected based on the modality used to generate the response to the query.

### INCORPORATION BY REFERENCE; DISCLAIMER

Each of the following applications are hereby incorporated by reference: Application No. 63/691,178 filed on Sep. 5, 2024; Application No. 63/691,172 filed on Sep. 5, 2024. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to techniques for data ingestion and retrieval for retrieval augmented generation (RAG) agents and/or related systems.

### BACKGROUND

Generative models are used in many applications to generate output, such as natural language, computer code, or images, based on input prompts. In various applications, the generation of content using a generative model is augmented by retrieving documents or other data from a knowledge base. However, ingesting documents so that they are stored for optimal retrieval from a knowledge base is a challenging task, particularly when the documents contain both textual and non-textual components. Inefficient ingestion leads to unwanted resource consumption, both during the ingestion and during downstream retrieval. Thus, there is significant computational and storage cost for inefficient ingestion. Accurately determining which data to retrieve for a query is challenging, particularly when the data is diverse in nature or includes documents that are multimodal. Retrieving too few documents results in missed information. Retrieving too many documents and/or performing unneeded encoding and decoding wastes computational resources or may introduce misalignment and/or hallucination into a response.

Techniques in this disclosure may address any of the aforementioned flaws, challenges, and difficulties by providing techniques that result in improved multimodal data ingestion and retrieval systems. The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a multimodal data ingestion and RAG agent system, in accordance with one or more embodiments;

FIG. 2A illustrates an example set of operations for ingestion of multimodal data, in accordance with one or more embodiments;

FIG. 2B illustrates an example set of operations for retrieval of multimodal data, in accordance with one or more embodiments;

FIGS. 3A-F illustrate example techniques for multimodal data ingestion and retrieval, in accordance with one or more embodiments;

FIG. 4 illustrates an example machine learning engine, in accordance with one or more embodiments;

FIG. 5 illustrates example operations for machine learning, in accordance with one or more embodiments; and

FIG. 6 illustrates a block diagram of a computer system, in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. MULTIMODAL RAG AGENT DATA INGESTION AND RETRIEVAL SYSTEM
3. MULTIMODAL DATA INGESTION OPERATIONS
4. MULTIMODAL DATA RETRIEVAL OPERATIONS
5. EXAMPLE MULTIMODAL DATA INGESTION AND/OR RETRIEVAL TECHNIQUES
6. MACHINE LEARNING ARCHITECTURE
7. MACHINE LEARNING OPERATIONS
8. GENERATIVE ARTIFICIAL INTELLIGENCE MODELS
9. COMPUTER NETWORKS AND CLOUD NETWORKS
10. MICROSERVICE APPLICATIONS
11. HARDWARE OVERVIEW
12. MISCELLANEOUS; EXTENSIONS

### 1. General Overview

One or more embodiments provide a technique for multimodal data ingestion and/or multimodal query response using multimodal data retrieval. Data is retrieved from a knowledge base to respond to user queries by providing information used to generate the response. Embodiments of the multimodal document ingestion and multimodal document retrieval system disclosed herein facilitate efficient and accurate ingestion and retrieval of data and generation of responses to queries based on retrieving the ingested multimodal data.

During ingestion, a document is chunked into text chunks, image chunks, and/or chunks for graphical data (e.g., a graph, a chart, a table, a plot, a diagram, a frequency distribution, a histogram, a pictograph, a knowledge graph, or the like). A text corpus is generated for the chunks. The system generates a summary of the text chunk, a text description of the image chunk and/or a structed text representation of the data illustrated by the graphical data. The text description of the image chunk is stored. A cross-embedding of the text description and the image is generated and stored. The system extracts data points from the graphical data using a graphical data point extraction model. The system generates and stores a structured text representation of the data illustrated by the graphical data representation, with associated labels, captions, axis, title text, etc. A cross-embedding of the structured text representation and the graphical data representation is generated and stored.

During retrieval, chunks corresponding to a query are identified using semantic matching based on the query and the text summary or the text chunk, the text description of the image, and/or the structured text representation of the illustrated data is used to identify chunks. In some cases, such as when a query requires multimodal reasoning and/or when semantic matching produces insufficient results, the system performs an embedding search during retrieval. In this case, a cross-embedding of the query is generated and used to identify one or chunks based on similarity between the cross-embedding of the query and the cross-embedding of the text description and the image and/or the cross-embedding of the structured text representation and the graphical data representation.

Documents in a knowledge base are retrieved using a semantic search, an embedding search, or other techniques. A semantic search technique matches similarity in language to determine the most relevant results. An embedding search involves matching vector embeddings of a query to vector embeddings of documents or components of documents. The embedding search process is more computationally expensive than a semantic search or semantic match and so is performed based on insufficiency of a semantic search, responsive to a modality keyword being included in the query, and/or responsive to the query including multimodal content.

In general, A Large Language Model (LLM) is a type of AI trained on vast amounts of text data to generate human-like responses and perform various natural language processing tasks, such as translation, summarization, or answering questions. A Multimodal Large Language Model (MLLM) extends LLMs by integrating multiple types of input (e.g., text, images, or audio), enabling the model to process and generate outputs that combine modalities, such as describing an image or generating captions. A Large Multimodal Model (LMM) is similar to an MLLM but may emphasize broader or less text-centric multimodal interactions, such as combining video, spatial, and/or audio data.

Generating separate summaries of the textual and graphic components of multimodal documents and storing the summaries reduces the need for expensive embedding generation and matching. In various embodiments, the multimodal document and/or one or more embeddings for the multimodal document are stored together with or separately from the summaries for the text elements, components of the graphic elements, and/or other visual elements. Ingesting documents in this way into the knowledge base facilitates identifying and retrieving components of multimodal documents in a resource and time-efficient manner during response generation tasks using the knowledge base.

For a particular multimodal document, the multimodal document ingestion system parses the document to determine textual and non-textual components. The system uses a first model to generate a summary of the textual elements of the multimodal document. The system uses a second model to generate a summary of the non-textual components. The system uses a third model to recognize non-textual components that include images and/or non-textual components that include a graphical representation of data (such as a chart, graph, or data point plot). The system uses a data extraction model for extracting data points from graphical data representations.

The system generates a text summary of the data points using a data point summary model and/or using the data point extraction model. The system generates a summary for text included in graphic components such as charts, graphs, or data points using a language model to summarize titles, labels, units, captions, and/or other textual portions of the graphic component. In some embodiments, a summary for a graphic component is generated using metadata for the graphic component, such as image metadata, and the text in the graphic component, and a summary is generated separately for extracted data points.

Traditional RAG systems primarily process unimodal data, such as text or images, limiting their ability to understand and respond to real-world scenarios that involve multiple data types. This unimodal limitation hinders the performance and applicability of RAG systems. For applications where multimodal data is prevalent, enhancements that facilitate multimodal ingestion increase efficiency. Some examples are the following:

Traditional RAG systems are unable to retrieve documents using non-text-based modality. Embodiments of the multimodal data ingestion and retrieval framework disclosed herein cohesively integrate multimodal documents for response generation by a RAG agent using data sources that are multimodal. The specialized data ingestion and retrieval facilitates response be the multimodal RAG agent by producing more accurate retrieval and by increasing response quality with minimal to no additional computation cost compared to traditional systems.

Applicant notes that this Overview is non-limiting in nature, and that additional embodiments and related combinations of features are described in this Specification and/or recited in the claims.

### 2. Multimodal Rag Agent Data Ingestion and Retrieval System

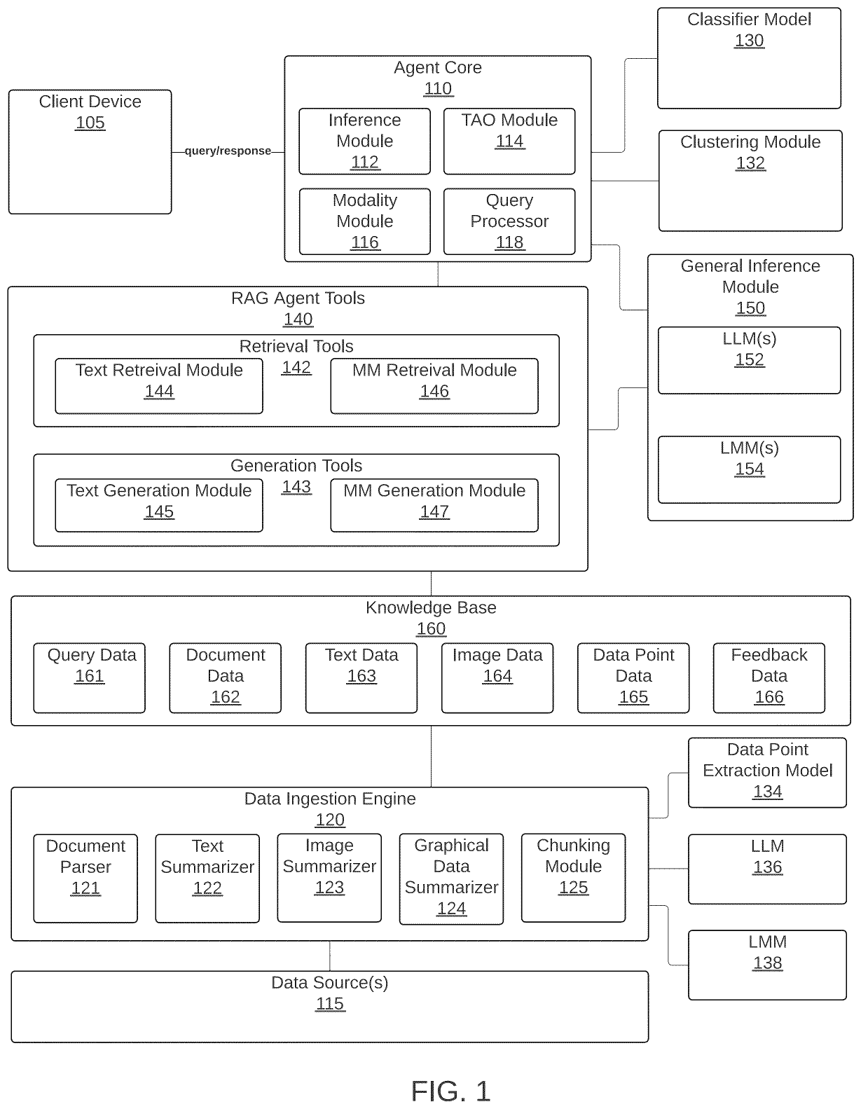

One or more embodiments include a multimodal RAG agent system 100 for data ingestion, data retrieval and/or query response. In FIG. 1. the system 100 facilitates ingesting multimodal data such as documents having text, images, graphs, captions, etc., retrieving multimodal data, such as document chunks and/or embeddings, and/or generating responses to queries or other user input using ingested and/or retrieved data.

In FIG. 1, the system 100 includes a client device 105, an agent core 110, a classifier model 130, a clustering module 132, RAG tools 140, a general inference module 150, and a knowledge base 160. In FIG. 1, the system 100 also includes one or more data sources 115, a data ingestion engine 120, a data point extraction model 134, an LLM 136, and/or an LMM 138.

In FIG. 1, the client device 105 represents one or more computing devices such as one or more computers, smart phones, and/or other computing devices. In various embodiments, the agent core 110 is a multimodal RAG agent core that performs actions related to receiving and/or accessing a query from the client device 105 and/or generating a response to a query received from the client device 105. In various embodiments, the agent core 110 performs actions related to generating a response to a query received from the client device 105. The agent core 110 deploys the retrieval tools 142 of the RAG agent tools 140 to search, filter, extract, and/or otherwise retrieve data from the knowledge base 160, and the agent core 110 deploys generation tool 143 to generate text or multimodal content. In embodiments, the retrieved data is provided to a generative model as context along with the associated query from the client device 105 to cause the generative model to generate an enhanced response.

In the example, the agent core 110 includes an inference module 112, a thought/action/observation (TAO) module 114, a modality module 116, and a query processor 118. In various embodiments, the agent core 110 deploys various RAG tools 140 to perform various retrieval and generation tasks. For example, the RAG tools 140 include one or more retrieval tools 142 used to search, filter, extract, and/or otherwise retrieve data from the knowledge base 160, and/or the RAG tools include one or more generation tools 143 used to generate, organize, and/or format text or non-textual content. In embodiments the agent core 110 also deploys a classifier model 130, a clustering module 132, and/or a general inference module 150 and/or.

The inference module 112 of the agent core 110 generates one or more thoughts or inferences based on input received by the agent core 110. The thoughts or inferences include an identification of needed information. In embodiments, the inference module 112 generates requests for documents based on a modality associated with a query and/or associated with responding to the query. The inference module 112 includes components that process retrieved documents and queries to generate a prompt or context to be provided to language model via the general inference module 150 or the RAG agent tools 140.

The TAO module 114 of the agent core 110 is a framework that operates in a Thought-Action-Observation cycle. The TAO module iteratively reasons (thought), interacts with external systems or performs actions (action), and/or processes new information or feedback (observation) to refine its understanding and actions by setting or adjusting parameters of one or more of the various models deployed by the agent core 110. In embodiments, the TAO module 114 generates a thought, action, or observation based on a modality associated with a query and/or associated with responding to the query. In general, the inference module 112 performs static response generation, whereas the TAO module 114 enables dynamic and iterative problem-solving using feedback.

The modality module 116 includes components for analyzing a query to determine one or more modalities associated with the query. For example, the modality module determines, based on attributes of the query, one or more modalities associated with generating a response to the query. In various embodiments, the modality module 116 includes components, such as logic and/or models, for identifying a modality based on a modality keyword of a query, a content type included in the query, a content type associated with data used to respond to the query, and/or another content type associated with an output of a tool, model, or module, etc.

In some embodiments, the modality module 116 determines one or more modalities of the query based on one or more modality keywords in the query. In embodiments, the modality module 116 identifies a modality associated with feedback received for one or more responses generated at least in part by the agent core 110. The modalities identified by the modality module determine the modality of the types of generation, retrieval, reasoning, and/or feedback-based training models, etc., deployed by the system. Modality types of RAG agent tools 140 for retrieval and generation are selected based on the modalities determined by the modality module. For example, the modality module 116 determines a non-text modality for a query based on text-modality being insufficient to answer the query or based on the query processor 118 determining that non-text modality is requested for the query.

The query processor 118 includes components for analyzing incoming queries to determine the content and various attributes of the queries. For example, the query processor 118 identifies attributes of the query such as tone, intent, topic, etc., The query processor also determines attributes of a query related to determining one or more modalities associated with the query. The query processor 118 provides modality-related information for a query to the modality module. For example, a query that asks to summarize, in text, an image appearing in a frame of a video is identified by the query processor to be text-modal, image-modal, and video-modal. The modality module 116 determines the modality of RAG agent tools 140 used to answer the query based on the modality information from the query processor 118 and other modality information, such as feedback received for a previous response or the sufficiency of available text information. In another example, the query processor 118 identifies text modality and graphical data modality for a query that requests a summary of a chart in a document.

The agent core 110 deploys RAG tools 140 to generate responses based on retrieved data. In various embodiments, the agent core 110 includes RAG tools or accesses RAG tools via an application programing interface (API). As shown, the RAG tools include a retrieval tool 142 having a text retrieval module 144 and a MM retrieval module 146. The RAG tools also include a generation tool 143 that has a text generation module 145 and a MM generation module 147.

The retrieval tools 142 include components for generating requests for documents from a knowledge base 160 and/or obtaining the documents from the knowledge base 160. The text retrieval module 144 includes functions and/or algorithms for finding, extracting, or otherwise obtaining text-based information. The MM retrieval module 146 performs retrieval of multimodal data, such as images, audio, or video.

The generation tools 143 generate content based on retrieved documents. In embodiments, the retrieved documents are multimodal and include text as well as images. The text generation module 145 generates text based on text or images retrieved by the retrieval tool 142. The MM generation module 147 performs generation of multimodal responses based on text or images retrieved by the retrieval tool 142. In various embodiments, different multimodal responses include content types such as images, audio, video, or a combination of the types.

In some embodiments, a classifier model 130 receives a query and/or input from the agent core 110 generated in association with the query by the inference module 112, the TAO module 114, the modality module 116, and/or the query processor 118. The classifier model 130 determines one or more classes associated with the query by performing aggregation and/or classification operations on the query. For example, the classifier model 130 is used by the agent core 110 to determine a classification of a query received from the query processor 118 and classification of a thought or action generated by the agent core TAO module 114. The agent core 110 receives the classification, and the classification is used by the modality module 116 to determine what modalities of retrieval and/or generation are needed or likely to be needed to respond to the query. In embodiments, the classification is also used as feedback and or training data for the inference module 112, the TAO module 114, the modality module 116, and/or the query processor 118.

In various embodiments, the clustering module 132 performs operations to group, organize, or cluster queries, responses, and/or data from the knowledge base 160 into sets of related items. For example, queries relating to particular topic are received by the clustering module 132 from the agent core 110. The queries are processed into one or more clusters or groups representing association with a property of the group. For example, queries related to a topic are clustered into groups based on a likelihood of being successfully answered using a modality or modalities.

In FIG. 1, the general inference module 150 is deployed by the agent core 110 to generate inferences, answers, or other output based on a query received from the client device 105. The general inference module 150 also generates output based on data retrieved from the knowledge base 160 that is provided as context with the query. The retrieved data is provided to the general inference module 150 by the agent core 110 as context along with the query from the client device to generate content which the agent core 110 processes and/or provides to the client device 105 as a response to the query.

The general inference module 150 includes one or more different LLMs 152 and/or LMMs 154. The LLM 152 is any suitable language model for generating responses to input queries. In some embodiments, the LLM is a language model trained for generating natural language and/or structured responses. In other embodiments, the LLM is a general language model. Example LLMs include GPT, LaMDA, LLaMa, T5, and other models.

The LMM 154 is any suitable large multimodal model (LMM) or multimodal large language model (MLLM) for generating images (or other media) based on input images and/or text, generating text based on input images and/or text, etc. In some embodiments, the LMM is a language model trained for generating natural language and/or structured responses. In other embodiments, the LMM is a general multimodal model. Example LMMs include Palm-E, Dall-E, Gemini and GPT-4o.

In the example of FIG. 1, the knowledge base 160 includes query data 161, document data 162, text data 163, image data 164, data point data 165, and/or feedback data 166. The knowledge base 160 accepts data from various data sources, optionally performs processing or preprocessing tasks on the data, and/or maintains the data stored in the knowledge base 160. In embodiments, some or all of the data in the knowledge base 160 is stored in a vector format representation.

In various embodiments, query data 161 includes data related to queries, including modality keywords, related user histories, preferences, related conversation history and/or other attributes of the query, etc. The document data 162 includes data related to documents (e.g.,. pdf or. docx, etc.) ingested from various data sources. Text data 163 refers to text based or characterized data. In various embodiments, documents contain text, images, and graphical data point representations (e.g., charts, graphs, etc.). For example, text data includes document chunks comprising text. Image data 164 refers to various formats of digital image files (e.g., .img, .tiff, .jpeg, etc.) and/or related metadata. Data point data 165 includes data related to graphical representations of data such as charts, graphs, tables, etc. This data includes headers, axis names, labels, captions, and/or other metadata related to the graphical data point data. In embodiments, other types of media file and/or other types of data (e.g., sound data, video data, sensor data, etc.) are also stored in the knowledge base 160.

In embodiments, the feedback data 166 includes various data collected from one or more client devices 105. For example, feedback data includes attributes of a conversations, attributes of queries in a conversation, an attribute of a client device, etc., and/or other direct and/or indirect feedback related to one or more responses from the agent core 110 to the client device 105.

In FIG. 1, the system 100 includes a data source 115. Various data sources 115 include external knowledge bases, data repositories, data storage, object storage, vector storage, etc. Data types include text documents,. pdf files, structured data, unstructured data, image files, video files, audio files, records, histories, and/or the like. For example, a data source 115 provides documents, records, or other data including text, images, and graphical data portions such as charts, figures, graphs, etc. to the data ingestion engine 120.

As shown, the data ingestion engine 120 includes a document parser 121, a text summarizer 122, an image summarizer 123, a graphical data summarizer 124, and a chunking module 125. In the example, the data ingestion engine 120 processes data from data source 115, and the processed data is stored in the knowledge base 160.

The document parser 121 parses input documents from the data source 115 and identifies text-based portions and non-text-based portions of documents. For example, a .pdf file contains text, images, and charts in line with the text. The document parser 121 parses the document so that the text portion of the document is delineated from the images and charts in line with the text in the document. Depending on the result of parsing, the document parser 121 provides components of the documents, or the whole document, to the text summarizer 122, the image summarizer 123, the graphical data summarizer 124, and/or the chunking module 125.

The text summarizer 122, generates text summaries from textual components of documents. In some embodiments, the text summarizer 122 inputs parsed and/or chunked text components of a document (such as a .pdf) into a language model, such as LLM 136, to cause the language model to generate a summary of the input text. In various embodiments, various LLMs are deployed to generate one or more text summaries of one or more chunks of documents received from data source 115.

The image summarizer 123 includes one or more models and/or algorithms that produce a text summary of an image received from data source 115. The image summarizer includes models and/or algorithms that produce a text version of an image. For example, a large multimodal model receives an image and a prompt with instructions to generate a summary of the image and/or a description of the contents of the image. In embodiments, text appearing in the image is extracted from the image and input into the large multimodal model. In embodiments, extracted text is provided to the text summarizer 122 and/or a to a separate model, such as LLM 136 or LMM 138. For example, text in an image is recognized by OCR and input (1) into an LLM 136 to generate a summary of the OCR text and/or (2) into a LMM 138 to generate a summary of the image. Captions, titles, labels, or other metadata associated with the image is also provided to such an LLM 136 or LMM 138.

The graphical data summarizer 124 generates text summaries of graphical data elements of documents. For example, the graphical data elements of a .pdf include data points, tables, charts, graphs, plots, trees, maps, or other graphical representations of data. The graphical data summarizer includes an interface for communicating with the data point extraction model 134. The graphical data summarizer extracts 124 data points and corresponding values for the data points from the graphical data elements. For example, the graphical data summarizer 124 extracts numerical values, captions, labels, titles, and/or other components of the graphical data elements of a document by processing the text and/or metadata of the document. The extracted data points and other attributes of the graphical data elements (axis label, caption, title, key, etc.) are input into a language model, such as LMM 138, to generate a summary of the graphical data elements of the document.

In FIG. 1, the chunking module 125 includes components and features that break data from the data source 115 into portions called chunks. Different chunking techniques are deployed by the chunking module 128 to efficiently process multimodal documents for optimal ingestion. For example, documents are chunked into one or more of: a text chunk, an image chunk, and a graphical data chunk. In embodiments, a text chunk is identified that corresponds to an image chunk and/or a graphical data chunk based on the language of the text chunk referencing the image chunk and/or graphical data chunk. The system tracks text chunks that directly reference an image or graphical data element. These referencing chunks are included as context with the image or graphical data element. In embodiments, an image or graphical data chunk and a referential text chunk that refers to the image or graphical data chunk are provided to an encoder to generate an embedding and/or to a language model to provide a text summary or description.

The data point extraction module 134 is a model trained to extract data points from graphical components of documents. For example, a data point extraction module defines a set of values based on attributes of the graphical component.

The LLM 136 is any suitable language model for summarizing input text. In some embodiments, the LLM is a summarizer model trained for generating natural language and/or structured summaries. In other embodiments, the LLM is a general language model. Example LLMs include GPT, LaMDA, LLaMa, T5, and other models.

The LMM 138 is any suitable large multimodal model (LMM) or multimodal large language model (MLLM) for summarizing input images or text, generating responses to input images or text, and/or generating responses including images or text in response to prompts. In some embodiments, the LMM is a summarizer model trained for generating natural language and/or structured summaries. In other embodiments, the LMM is a general multimodal model. Example LMMs include Palm-E, Dall-E, Gemini and GPT-4o.

In one or more embodiments, a machine learning algorithm is an algorithm that can be iterated to train a target model f that best maps a set of input variables to an output variable. In particular, a machine learning algorithm is configured to generate and/or train data point extraction model, an agent model, a classifier model, an LLM, an LMM, or another machine learning model.

A machine learning algorithm is an algorithm that can be iterated to train a target model f that best maps a set of input variables to an output variable, using a set of training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm, which in turn updates the target model f.

A machine learning algorithm generates a target model f such that the target model f best fits the datasets of training data to the labels of the training data. Additionally, or alternatively, a machine learning algorithm generates a target model f such that when the target model f is applied to the datasets of the training data, a maximum number of results determined by the target model f matches the labels of the training data. Different target models are generated based on different machine learning algorithms and/or different sets of training data. In embodiments, various models deployed by the multimodal data ingestion system are trained using training data including prompts and efficacy scores as feedback for the prompts.

A machine learning algorithm may include supervised components and/or unsupervised components. Various types of algorithms may be used, such as linear regression, logistic regression, linear discriminant analysis, classification and regression trees, naeïve Bayes, k-nearest neighbors, learning vector quantization, support vector machine, bagging and random forest, boosting, backpropagation, and/or clustering.

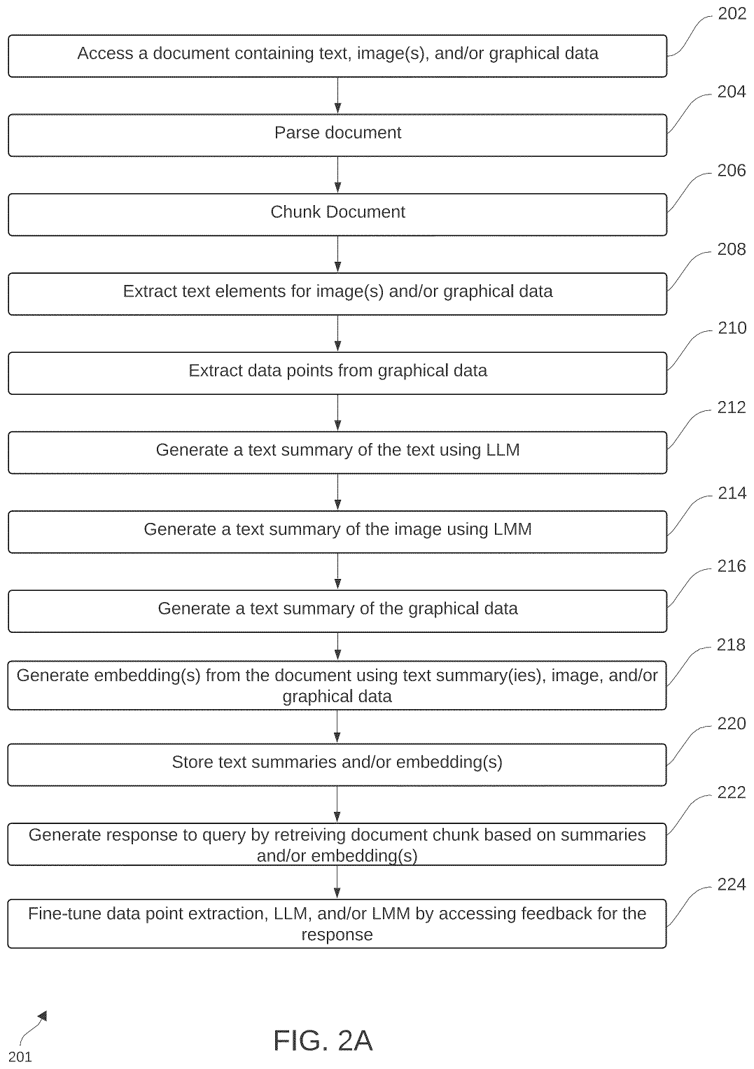

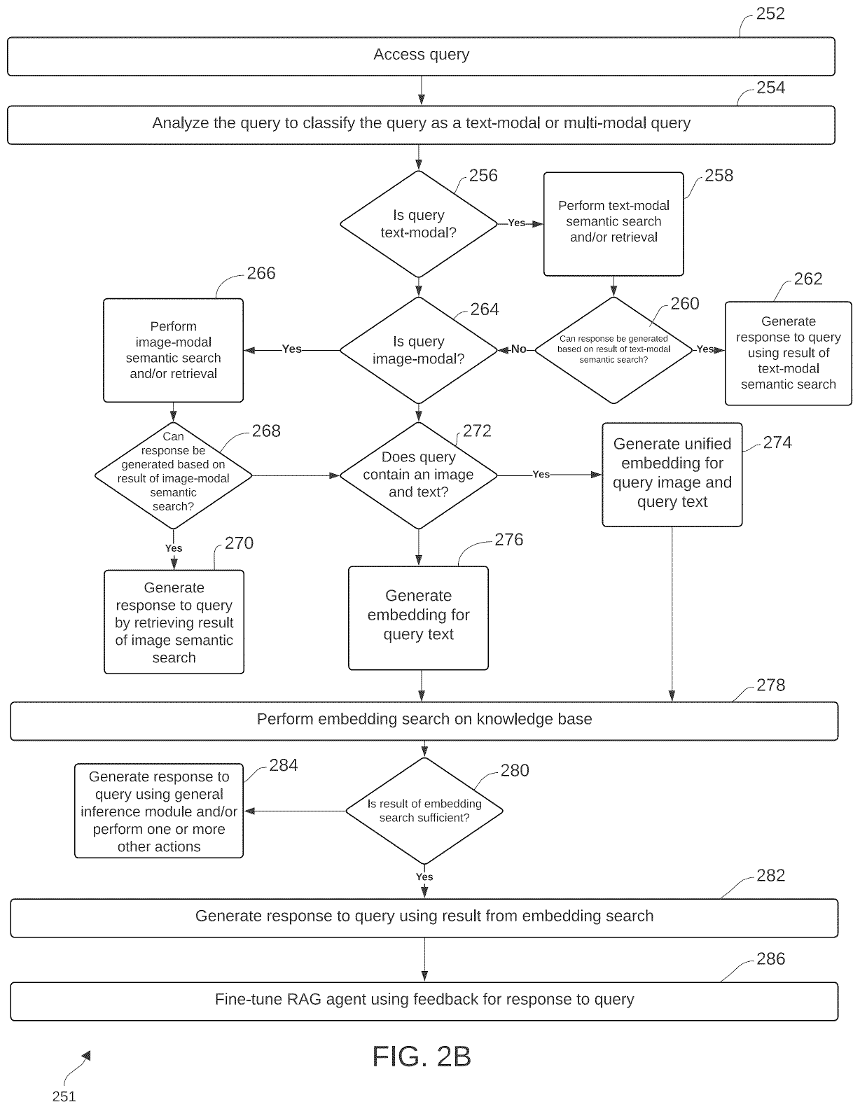

Examples of operations that may be performed by the system 100 are described below with reference to FIG. 2. As shown, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, an interface refers to hardware and/or software configured to facilitate communication between a user and a system. In FIG. 1, one or more interfaces are used to facilitate communication between the system 100 and/or one or more computing devices. Such an interface renders user interface elements and receives input via user interface elements. Examples of interfaces include a GUI, a command line interface, a haptic interface, and a voice command interface. Examples of user interface elements include checkboxes, radio buttons, dropdown lists, list boxes, buttons, toggles, text fields, date and time selectors, command lines, sliders, pages, and forms.

In various embodiments, different components of such an interface are specified in different languages. The behavior of user interface elements is specified in a dynamic programming language such as JavaScript. The content of user interface elements is specified in a markup language, such as hypertext markup language, extensible markup language, user interface language, or another markup language. The layout of user interface elements is specified in a style sheet language such as cascading style sheets. In embodiments, interfaces are specified in one or more other languages, such as Java, C, C++, or another programming language.

### 3. Multimodal Data Ingestion Operations

FIG. 2A illustrates example operations for a method 201 of multimodal data ingestion, according to embodiments.

In the example, the system accesses a document containing text, one or more images, and graphical data (Operation 202). For example, a document (such as a medical report, financial report, etc.) that contains text, images, charts, and graphs and is saved in a word processor format (e.g., .docx) or portable document format (e.g., .pdf) and accessed by the system. In general, documents of various standardized formats suitable for presenting images and text are accessed from various data sources and/or stored by the system. Various formats define the formatting and/or placement of the components of the documents, including formatted or unformatted textual components and/or nontextual components such as images or graphs. In embodiments, the system accesses a plurality of documents contained in a file system.

The system parses the document (Operation 204). The system parses one or more input documents by identifying text-based portions and non-text-based portions. The system identified different types of non-text-based portions. For example, a. pdf file contains text and charts, graphs, or other images. The system parses the document so that the text portion of the document is delineated from the images. The images, however, sometimes have textual elements such as captions, labels, titles, legends, and/or text appearing in the image. In embodiments, the system parses the structure and contents of the text components of the documents. Depending on the result of parsing, the document parser provides components of the documents, and/or the whole document to one or more models to generate one or more summaries for the components and/or documents. Also, some documents have graphical data components, such as tables, graphs, charts, plots, and the like. The system parses the graphical data components of the documents.

The system chunks the document (Operation 206). Chunking involves breaking the data for documents into smaller pieces of data for more efficient processing. In some embodiments, the system applies techniques for chunking multimodal documents that perform operations based on the modality associated with portions of data for documents. An example multimodal chunking technique is described in section 3.A., below. In embodiments, the system chunks the documents into one or more text chunks for text, image chunks for one or more images, and/or graphical data chunks for graphical data contained in the document. The chunks are identified by an identifier for the document and a chunk number and/or chunk type for the chunk.

The system extracts text elements for the one or more images and/or the graphical data (Operation 208). In embodiments, a document chunk for an image or graphical data component of a document includes a label, caption, title, legend, axis label, or metadata text. Such text elements are extracted from the data for the image or graphical data component. In some embodiments, the image or graphical data component is processed using optical character recognitions to extract text elements.

The system extracts data points from the graphical data (Operation 210). In embodiments, a data point extraction model is trained and/or fine-tuned to identify data points and/or generate text based on identified data points contained in graphical data (e.g., graphical data components of document chunks). Example techniques for extracting data points from graphical data components, training a data extraction model, and fine-tuning a data point extraction model are described in section 3.B., below.

The system generates a summary text summary of the text using an LLM (Operation 212). For example, a document contains a number of textual document chunks. The textual document chunks are processed using a language model to generate one or more summaries or descriptions of the contents of the textual document chunks. In embodiments, the system generates a text summary of a document chunk that references an image or graphical data. In this case, the system associates the text summary with the corresponding image or graphical data, an embedding of the corresponding image or graphical data, and/or a text description or summary of the corresponding image or graphical data. In embodiments, the system provides the textual components to a generative model to generate summaries of the textual components. Various suitable generative models include GPT-4, LLaMa, Text-To-Text Transfer Transformer (T5), Bidirectional Encoder Representations from Transformers (BERT) models, etc.

The system generates a text summary of an image using an LMM (Operation 214). In various embodiments, the system provide an image to a pre-trained image classification model to receive an identification and/or description of the image and/or objects in the image. In embodiments, related text, such as extracted OCR text, metadata text, and/or referencing text from a text chunk, is provided to the LMM as context. The LMM generates the text summary of the graphical data based on the image and the context.

The system generates a text summary of the graphical data (Operation 216). In embodiments, the system provides the extracted data points to a language model to generate a summary of the extracted data points. The system provides the summary of the extracted data points and the graphical data to a multimodal model to generate the text summary of the graphical data. Related text, such as extracted OCR text, metadata text, and/or referencing text from a text chunk, is provided to the multimodal model to generate the text summary of the graphical data.

The system generates one or more embeddings from the document using one or more text summaries, one or more images, and/or graphical data (Operation 216). The system performs various operations to generate vector embeddings from document chunks of one or more documents. For example, the system extracts features of the data and flattens the features into a high-dimensional vector, capturing the essential characteristics of the input in an embedded format. Embedding vectors'numerical representation of the document or chunk enable efficient comparison, clustering, or retrieval in downstream tasks. In embodiments, separate embeddings are generated for textual components images, and graphical data components of the document. For example, the document is chunked by modality into a set of chunks, and separate embeddings are generated for the set of chunks based on the modality or modalities of the set of chunks.

The system stores the text summaries and/or the one or more embeddings (Operation 220). In various embodiments, the text summaries are stored in a text-based format in a first data storage. The embeddings are stored in an array, matrix, or vector embedding-based.

The system generates a response to a query by retrieving a document chunk based on the summaries and/or the one or more embeddings for the document (Operation 222). In various embodiments, the document is retrieved responsive to a semantic search or match and/or a vector embedding search or match. Semantic matches are determined based on the text summaries. The graphical components, textual components, or portions thereof are used for generating the response to the query. Further details regarding query response and/or document chunk retrieval are described with respect to FIG. 2B, below.

The system fine-tunes a data point extraction model and/or one or more language models based on feedback for the response (Operation 224). In embodiments, responses include direct and/or indirect feedback for a response generated based on a text, image, or graphical data component of a document. For example, feedback is provided to a data point extraction model describing an accuracy of the data point values extracted from a graphical data component of a document. In another example, feedback describing the accuracy or validity of a description of an image is received by the system. In this way, the data extraction model is optimized by feedback regarding the accuracy of the extracted data points. Also, an LMM used to generate an image summary is optimized by feedback regarding the accuracy of an image description. Feedback is provided to the data extraction model and/or the language model to optimize extraction of data points and/or generation of summaries of the graphical data components of the document.

### 4. Multimodal Data Retrieval Operations

FIG. 2B illustrates example operations for a method 251 of multimodal data retrieval and/or query response generation, according to embodiments.

In the example, the system accesses a query (Operation 252). In general, a query is input by a user of a client device transmitted electronically to the system. Queries include natural language questions, instructions, requests, and the like. In embodiments, multimodal queries include text and images.

The system analyzes the query to classify the query as a text-modal or multimodal query (Operation 254). A classifier model is used to evaluate the query to determine the modality, or modalities, of one or more documents needed to answer the query. A query asking for a summary of a text document is a text-modal query. A query that is text-modal and image-modal is multimodal. For example, a query asking for a textual comparison of objects in an image is a multimodal query, since a text mode component and an image mode component are used to response to the query.

The system analyzes the query's content to understand the type of information that is requested by the query, whether the query can be adequately addressed using text alone, and/or the modalities of information sources for information requested by the query. In various embodiments, the system analyzes the query to identify keywords, context, complexity, format, and/or intent of the query. A non-limiting list of keywords indicating image modality include “show,” “look,” “view,” “listen,” “watch,” “sound,” “picture” or other keywords indicating inclusion of an image, sound, video, or other non-text-modal component of a knowledge base file. Non-limiting examples of keywords for identifying a query as text-modal include “paragraph,” “story,” “novel,” or “read. ” The system analyzes the query's content to understand the type of information that is requested by the query, whether the query can be adequately answered using text, and if other modes are needed to adequately answer the query. The classifier provides an identification of the modes associated with a query.

The system determines if the query is text-modal (Operation 256). A text-modal query is a query that is answerable or likely to be able to be answered using documents having text-based components. The system determines the query is text-modal based on the classifier identifying the query as text modal.

If the query is text-modal, the system performs text-modal semantic search and/or retrieval (Operation 258). For example, the system uses the text of the query to search for semantically similar text contained in documents in the knowledge base and/or retrieves one or more of the matching documents. The system retrieves semantically similar documents based on a threshold similarity, a ranking, a weighting, or some other criteria.

The system determines if a response can be generated based on the result of the text-modal semantic search and/or retrieval (Operation 260). For example, in embodiments, if no results are identified by the search, or only results not meeting sufficiency criteria are identified, the system stores the results and/or performs other searches before generating a response to the query.

If a response can be generated based on the result of the text-modal semantic search and/or retrieval, the system generates the response to the query by using the result of the text-modal semantic search (Operation 262). The system generates the response by providing the text of the search results as context with the query to an LLM and including the output of the LLM in the response. In embodiments, if the text-modal semantic search does not return any results or the results are insufficient, the system does not generate output from the LLM based only on the results returned from text-modal semantic search and the query. Instead, in some embodiments, the system proceeds to perform an embedding search using an encoding of the query, and the system generates the response using the results of the embedding search as contextual input into an LLM.

The system determines if the query is image-modal (Operation 264). An image-modal query is a query that is answerable or likely to be able to be answered using documents having image-based components. The system determines whether the query is image-modal based on the classifier identifying the query as image modal.

If the query is image-modal, the system performs an image-modal semantic search and/or retrieval (Operation 266). The system semantically searches textual elements of images in the knowledge base. Images (and other non-text-modal components) in documents have text textual elements associated with the images in titles, captions, legends, axis, metadata, descriptions. Also, images have textual elements displayed in the images that are recognizable using OCR. In embodiments, the system searches the textual elements of image based on the query to retrieve semantically similar documents based on a threshold similarity, a ranking, or some other criteria.

The system determines if a response can be generated based on the result of the image-modal semantic search (Operation 268). For example, in embodiments, if no results are identified by the search, or only results not meeting sufficiency criteria are identified, the system stores the results and/or performs other searches before generating a response to the query.

If the result of the image-modal semantic search and/or retrieval is sufficient, the system generates a response to the query by retrieving the result of the image-modal semantic search (Operation 270). The system generates the response by providing the text of the search results as context with the query to an LLM and including the output of the LLM in the response. In embodiments, if the text-modal semantic search does not return any results or the results are insufficient, the system does not generate output from the LLM based only on the results returned from text-modal semantic search and the query. Instead, in some embodiments, the system proceeds to perform an embedding search using an encoding of the query, and the system generates the response using the results of the embedding search as contextual input into an LLM.

The system determines if the query contains image and text (Operation 272). For example, the system analyzes a file type of a file associated with the query to determine that data associated with the query is an image file. In embodiments, the system provides the image to a classifier model to classify a type or sub-type of the image (e.g., chart, graph, histogram, picture, portrait, subject, topic etc. ,)

If the query contains an image and text, the system generates a unified embedding for the query image and query text (Operation 274). For example, a multimodal tokenizer is used to generate a sequence of tokens based on the query image (or other non-text component) and query text.

The system generates an embedding for the query text (Operation 276). For example, a tokenizer is used to generate a sequence of tokens based on the query text to result in a vector embedding of the query.

The system performs an embedding search on the knowledge base (Operation 278). In various embodiments, the system performs an embedding search using the embedding for the query text and/or a unified embedding for one or more query images and query text. The system locates embeddings in the database that are most similar to the query embedding from the query text and/or query image. In embodiments, the system uses cosine similarity, or another means of comparison, to determine similarity of embeddings.

The system determines if the result of the embedding search is sufficient (Operation 280). For example, in embodiments, if no results are identified by the embedding search, or only results not meeting sufficiency criteria are identified, the system stores the results and/or performs one or more other actions.

If the embedding search is sufficient, the system generates a response to the query using a result from the embedding search (Operation 282). The system decodes the retrieved vector embeddings. In embodiments, a plurality of vector embeddings are retrieved and scored or ranked by similarity to the query embedding using a similarity score and/or similarity ranking. The plurality of vector embeddings are decoded, and the plurality of decoded embeddings are given weights according to the similarities or ranks of the vector embeddings. The system provides the decoded vector embeddings retrieved from the knowledge base to an LMM as contextual input with the query to generate a response to the query. In embodiments, scores, weights, or ranks for the vector embeddings are provided to the LMM. The output of the LMM is processed or formatted by the RAG agent as needed and provided to the client device.

In embodiments, the RAG agent uses one or more of the stored results from a text-modal semantic search, an image-modal semantic search, and/or an embedding search to generate the response to the query. For example, a text-modal semantic search result is provided with a first weighting, an image-modal semantic search result is provided with a second weighting, and an embedding search result is provided with a third weighting. The RAG agent provides the results and the weightings with the query to an LMM and uses the output of the LMM to generate the response.

In embodiments, the system generates a response to the query using a general inference module and/or performs one or more other actions (Operation 284). In some embodiments, responsive to no documents or insufficient documents being identified by searching the knowledge base, the RAG agent generates a response using an LLM or LMM without retrieving a document from the knowledge base. In other embodiments, the RAG agent prompts or notifies a user device responsive to no documents being identified by searching the knowledge base. For example, the RAG agent causes the user device to display a notification that a document related to the query was not found.

The system fine-tunes the RAG agent using feedback for the response to the query (Operation 286). In embodiments, responses include portions that are generated based on portions of retrieved documents. Feedback scores corresponding to the respective portions of the response are provided for accuracy, consistency, alignment, completeness, and/or validity of the respective portions that are based on the retrieved document. In this way, the data extraction model is optimized by the feedback regarding the accuracy of the responses generated by the RAG agent.

### 5. Example Multimodal Data Ingestion and/or Retrieval Techniques

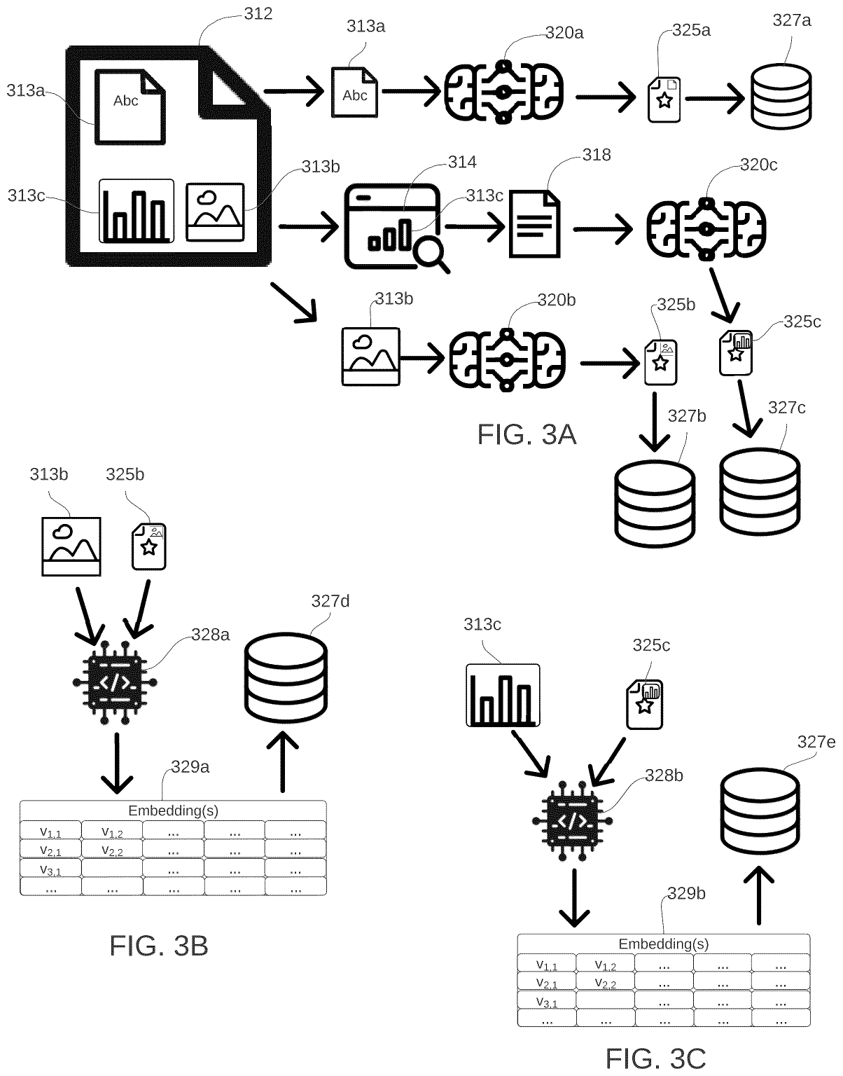

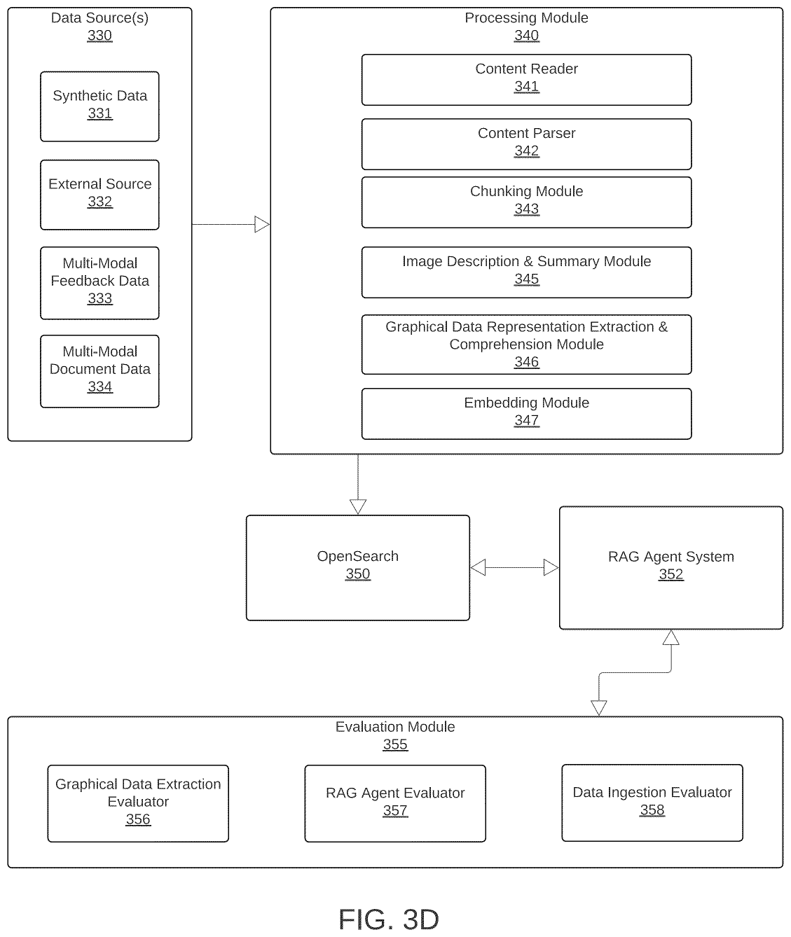

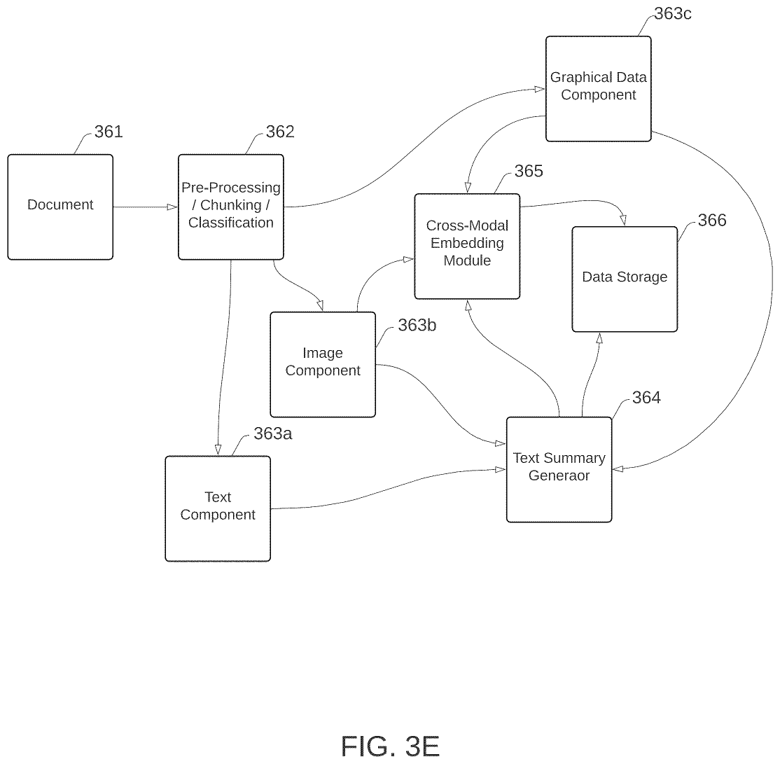

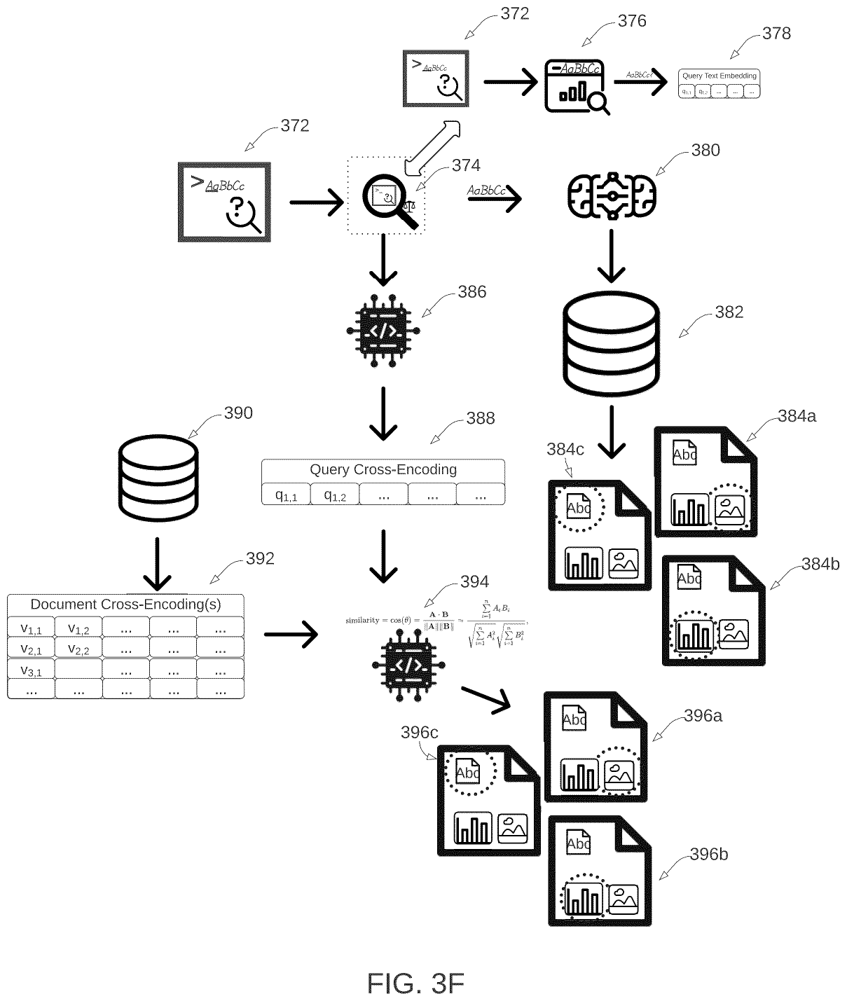

As shown in FIG. 3A, document 312, such as a .pdf file or .docx file, contains text 313a, an image 313b, and a bar graph 313c.

In FIG. 3A, the text chunk 313a is a document chunk containing header and/or body text of the document 312. The text chunk 313a is processed via a language model 320a to result in generated text 325a. The generated text 325a comprises a summary, topic, and/or keyword of the text chunk 313a. The generated text 325a is stored in a data store 327a.

As illustrated, the image 313b is extracted from a chunk of the document 312 containing the image. The image 313b is provided to a multimodal language model 320b that generates a text summary or description of the image. In embodiments, the document chunk including the image is analyzed for information such as metadata, captions, OCR recognizable text appearing in the image, and/or the like, and this information is also provided to the multimodal language model 320b to result in a generated text 325b that comprises a description, summary, topic or keyword associated with the image 313b. The generated text 325b is stored in a data store 327b.

As shown, the bar graph 313c is extracted from a chunk of the document 312 containing the bar graph 313c. The bar graph 313c is processed by a data point extractor 314 to result in a textual description 318 of the data points shown in the bar graph. The data point extractor 314 also extracts axis, labels, captions, etc., and records this information in the textual description 318. The textual description 318 is processed by a language model 320c to result in generated text 325c comprises a summary, topic, and/or keyword associated with the bar graph 313c as well as a description of the data points. In embodiments, the language model 320c is prompted to include a description of trends or patterns discovered by the language model 320c in the generated text 325c. The generated text 325c is stored in a data store 327c.

As shown in FIG. 3B, the image 313b and the generated text 325b for the image are input into a cross-encoder 328a. The cross-encoder 328a encodes the image 313b and the generated text 325b together into a vector format embedding 329a. The embedding 329a is stored in vector data storage 327d.

In FIG. 3C, bar graph 313c and the generated text 325c for the bar graph are input into a cross-encoder 328b. The cross encoder 328b encodes the bar graph 313c and the generated text 325c together into vector format embedding 329b. The embedding 329b is stored in vector data storage 327e.

In FIG. 3D, one or more data sources 330 provide data to a processing module 340. Types of data provided by the data sources 330 include one or more of: synthetic data 331, external source data 332, multimodal feedback data 333, and/or multimodal document data 334. Synthetic data includes data generated in various ways to mimic different types of other data, or random data. External source data 332 includes data received by the system from an external data source. Multimodal feedback data 33 includes feedback related to a conversation in which a response to a query was generated using more than one modality. Multimodal document data 334 includes various data items in formats that include more than one modality (e.g., more than one of a text modality, image modality, graphical data modality, audio modality, video modality or other data modality). In embodiments, various data point extraction models extract data points from data of various modalities based on the modality of the data. The system generates summary or description of the data points using a generative language model.

The processing module 340 comprises a content reader 341, a content parser 342, an embedding module 343, a text chunking module 344, an image description and summary module 345, and a graphical data representation extraction and comprehension module 346. The content reader 341 accepts incoming data. The content parser 342 parses the data. The content parser 342 determines document type and/or modalities associated with the document. The chunking module 343 accepts parsed documents and divides the documents into chunks.

The image description and summary module accepts image chunks and related textual information and generates a description or summary of the image. The image description or summary is provided with the image to a multimodal model to the embedding module 347 to generate a cross-embedding of the image. In some embodiments, referencing text from a text chunk is also provided to the embedding module 347.

In some various embodiments, the related textual information includes captions, labels, titles, and the like. In embodiments, the related textual information includes textual information from text chunks of a document, and text from related text chunks including the textual information is provided with the image to a multimodal model to generate the image description and/or summary.

The graphical data representation extraction and comprehension module 346 extracts data points, axis, labels, captions, and other information from graphical data. Also, the graphical data representation extraction and comprehension module 346 processes the data points to identify trends, patterns, relationships, and/or other attributes of the data and translate them into language form in a description or summary. The graphical data description or summary and/or the graphical data item is provided to a multimodal model to the embedding module 347 to generate a cross-embedding of the graphical data item. In some embodiments, referencing text from a text chunk is also provided to the embedding module 347. The embeddings are stored in an OpenSearch database 350. The descriptions and/or other data or metadata related to the documents is also stored in some embodiments.

The OpenSearch database 350 services a RAG agent system 352. The RAG agent system 352 is in communication with an evaluation module 355. The evaluation module 355 includes a graphical data extraction evaluator 356, a RAG agent evaluator 357, and a data ingestion evaluator 358. The evaluation module evaluates conversations (e.g., queries and associated responses) of the RAG agent system 352 to generate feedback and/or training data for various models deployed by the RAG agent system 352.

The graphical data extraction evaluator 356 evaluates the precision and/or accuracy of a value extracted from graphical data in a document. For example, the system identifies negative feedback indicating an extracted value is invalid or incorrect and provides the feedback as training data used by a data point extraction model.

The RAG agent evaluator 357 evaluates response generation, document retrieval, and reasoning performing by a RAG agent and/or various RAG agent tools. For example, the system identifies negative feedback indicating a retrieved document is not useful or that a useful document is not retrieved and provides the feedback as training data used by document retrieval model.

The data ingestion evaluator 358 rates and/or scores parsing, chunking, and embedding generation of the system. For example, the system identifies negative feedback indicating that a type of document or a type of document chunk has a low accuracy score for responses generated based on retrieving the document and provides the feedback as training data to a model used to chunk or parse the documents by document type or document chunk type.

As shown in FIG. 3E, a document 361 undergoes a pre-processing/chunking/classification stage 362 during which one or more of: pre-processing, chunking, or classification of the document occurs. The document 361 is chunked or parsed into a text component 363a, an image component 363b, and a graphical data component 363c.

The image component 363b is provided to a text summary generator 364 that generates a text summary of the image. The summary of the image and the image component 363b are input into a cross-modal embedding module 365, and the resulting embedding is stored in data storage 366. The graphical data component 363c is inputted into text summary generator 364 to result in a text summary of the graphical data component 363c. The summary and the graphical data component 363c are input into the cross-modal embedding module 365, and a resulting embedding is stored in the data storage 366. The text component 363a is provided to the text summary generator 364 to result in a text summary. The text summary and/or the text component is stored in data storage 366. In some embodiments, a text embedding and/or a cross-modal embedding of the text component and/or the text summary of the text component is generated and stored in the data storage 366.

FIG. 3F illustrates document retrieval for a query 372. The system analyzes the query at stage 374 to determine one or more modalities associated with the query. For example, a query is text-modal, image-modal, graphical-data-modal, sound-modal, video-modal, and/or another modality.

In the example, the query 372 includes one or more texts, images and/or graphical data components. The query is processed at stage 376 to generate one or more embeddings 378 of the query text. For example, the system generates an embedding of the text of the query. Also, the system extracts text from an images and/or graphical data in the query. In embodiments, a text embedding of the text of the query and extracted text from an image and/or graphical data is generated from the contents of the query. In embodiments, the system retrieves a document chunk based on similarity between a text embedding for document chunk and the query text embedding 378.

The text of the query 372 is received by a language model 380. The language model 380 retrieves information from a knowledge base 382 using a semantic search based on the text of the query. In embodiments, the system matches documents to the query. In the example, the system identifies a first document chunk 384a having an image based on a semantic match or similarity between the text of the query and text associated with the image (e.g., captions, title, labels, a language model generated summary). The system identifies a second document chunk 384b containing a graphical data component based on a semantic match or similarity between the text of the query and text associated with the graphical data component. The system identifies a third document chunk 384c containing text based on a semantic match or similarity between the text of the query and text of the document chunk. The system retrieves the document chunks 384a, 384b, 384c and provides the document chunks 384a, 384b, 384c as context with a prompt to a generative language model to generate a response to the query 372.

In some embodiments, the system uses a cross-encoder 386 to generate a cross-encoding of text of the query 372, text extracted from an image or graphical data of the query, and the image or graphical data of the query. Also, The system accesses a data store 390 storing document cross-encodings. The document cross-encodings 392 comprises a cross encoding of text of a document chunk, extracted text from an image or graphical data in the document chunk, and the image or graphical data. At stage 394, the system identifies one or more documents based on a cosine similarity between a cross-encoding 388 of the query 372 and one or more document cross-encodings 392 of the one or more documents.

In the example, the system identifies a first document chunk 396a having an image based on a similarity between the query cross-encoding 388 and a document cross-encoding 392 generated from the first document chunk. The system identifies a second document chunk 384b containing a graphical data component based on a similarity between the query cross-encoding 388 and a document cross-encoding 392 generated from the second document chunk. The system identifies a third document chunk 384c containing text based on a similarity between the query cross-encoding 388 and a document cross-encoding 392 generated from the third document chunk. The system retrieves the document chunks 392a, 392b, 392c and provides the document chunks 392a, 392b, 392c as context with a prompt to a generative language model to generate a response to the query 372.

In some embodiments, the system performs a semantic search using the text of the query to search a knowledge base before generating an embedding of the query. The system generates an embedding of the query and performs a vector search on a vector storage database using the embedding of the query responsive to the set of document chunks retrieved based on the semantic search using the query text being inadequate to answer the query. In some embodiments, a plurality of document chunks identified by a semantic search and a plurality of document chunks identified by cosine similarity of vector encodings are ranked and/or reranked. The document chunks and the rankings are input as context with a prompt into a generative language model to generate a response to the query 372.

Example Integrated RAG Agent Data Ingestion and Task Agent Pipeline:

In embodiments, an example system uses Integrated RAG Agent Data Ingestion together with RAG Agent Pipeline to perform End-to-End RAG Agent tasks. The pipeline integrates a list of critical modules, including object management system, file content reader, chunking pipeline, embedding section, and database settings, including but not limited to:
1. Object Management System: Ensures the smooth transfer of files between cloud bucket and created knowledge base.
2. Content Reader: Capable of reading various file formats such as txt, json, and pdf.
3. Chunking Pipeline: Implements a combination of fixed size, semantic, and layout chunking strategies to segment documents into coherent and manageable chunks. 4. Embedding Section: Supports model embedding selection and testing for different search paradigms. 5. Database Settings: Configurable for different databases like OpenSearch and Oracle DB, supporting multiple indexing and search pipeline configuration.
4. Embedding Section: Supports model embedding selection and testing for different search paradigms.
5. Database Settings: Configurable for different databases like OpenSearch and Oracle DB, supporting multiple indexing and search pipeline configuration.

The example provides the at least the following benefits:
1. Unified Chunking Framework: Integrated fixed size, semantic, and layout chunking strategies into a single adaptive pipeline.
2. Versatile Content Reader: Support multiple file formats includes a router for selecting the appropriate reader based on file type.
3. Advanced Embedding Models: Incorporates a selection and testing module for various embedding modules to enhance retrieval and generation accuracy.
4. Scalable Database Management: Supports multiple database settings and indexing
5. Enhanced Processing Efficiency: The integration of multiple chunking strategies ensures that documents are segmented in a manner that optimizes processing efficiency and relevance.
6. Improved Retrieval Accuracy: By maintaining semantic integrity within chunks, the pipeline enhances the accuracy and context of information retrieved by the RAG agent. 3. Flexibility and Scalability: The modular design and support for various file formats and database settings make the ingestion pipeline highly adaptable to different environments and requirements.
7. Provides a platform for embedding model development and evaluation of different Data ingestion settings (such as chunking strategy, chunking size, content reader, table support etc.).
8. Support Different OpenSearch/DB Settings (Ingestion Settings and Search Pipeline settings (inside and outside embedding)) based on file type. In addition, the data ingestion framework enables integration of fixed-size, semantic, and layout-based chunking strategies.

This advanced chunking framework enables optimal segmentation of unstructured and structured data types. The data ingestion framework leverages customized embedding model to better extract contextual information from domain data source (e.g., a customer, client, host, or seller). By collecting data to improve the adaptability of the model the ability for the file reader to read information is enhanced.

In embodiments, a router selects a file to read based on the filename. The system deploys one or more different readers for formats such as txt, json, pdf. Image Optical Character Recognition (OCR) is deployed in embodiments to read textual elements in non-text-based portions of the added documents. For example, the system reads elements from an image file that include a graphical component having text elements such as captions, labels, or text appearing in the image.

Different search techniques are deployed for testing and/or collecting data used for training and/or feedback. Output model embedding selection is tested for semantic, hybrid search, and text embedding or image embedding accuracy.

DB Data Ingestion: In the example, an OpenSearch schema is determined based on the type of content being indexed. For unstructured content, the schema is optimized for semantic search capabilities. Structured data sometimes utilizes a keyword-based schema. The ingestion process is tightly coupled with query time to ensure the data is indexed in a manner that maximizes retrieval efficiency. This integration allows the system to perform both key-word and semantic searches, depending on the needs of customers and applications.

### Example DB Data Search Pipeline

The ingestion system supports multiple database settings and indexing configurations to cater to diverse application needs. It includes support for OpenSearch and other databases, allowing flexible selection and configuration of database settings. The pipeline also supports multi-index ingestion, enabling hybrid searches with configurable weights for different search strategies.

### Example Chunking and Model Selection

The unified chunking framework dynamically adapts to the input content, choosing between fixed-size, semantic, or layout-based chunking strategies. For instance, fixed-size chunking might be used for large homogeneous text blocks, while semantic chunking would be applied to documents where preserving context is crucial. Layout-based chunking is employed for complex documents like. pdfs, where maintaining visual structure is important. This adaptive pipeline facilitates data segmentation in a way that optimally balances information retention and processing efficiency.

Example suitable embedding models include Cohere Embedding V3 and Mistral E5 embedding models. The embedding model selection module allows for the evaluation and comparison of different embedding techniques. This module supports a wide range of models, including those specialized for specific modalities (e.g., text or image embeddings) and those designed for multimodal data. The selection process is based on performance metrics related to retrieval and generation accuracy, allowing the system to identify the most effective embedding strategy for each use case. The OpenSearch schema is determined based on the type of content being indexed. For unstructured content, the schema is optimized for semantic search capabilities, while structured data may utilize a more traditional keyword-based schema. The ingestion process is tightly coupled with query time, ensuring that the data is indexed in a manner that maximizes retrieval efficiency. This integration allows the system to perform both semantic and hybrid searches, depending on the needs of the application.

Example suitable models include Phi-3-vision-128k-instruct and Chameleon models to convert images into contextual output. The scope of model selection within the pipeline is broad, encompassing a range of models from text-based to multimodal embeddings. The system considers factors such as the data modality and the specific requirements of the RAG application when selecting models. This ensures that the chosen model is well-suited to the task at hand, whether it involves understanding textual content, interpreting images, or integrating multimodal data.

As shown in FIGS. 3A-F, aspects of this disclosure enhance a data ingestion and service agent response pipeline. The system efficiently processes, understands, and generates responses from various data types, including text, images, tables, graphs, charts, and diagrams. This framework leverages the advanced capability of large language models to integrate and interpret multimodal data, significantly improving the versatility and utility of RAG systems.

In an embodiment, the framework consists of the following layers discussed further below: 1. Data Ingestion Layer: this layer enables the control of data flow from cloud to edge device in a range of formats, including text documents, images, structured data (e.g., tables and databases), and unstructured data (e.g., graphs and diagrams). In addition, the system performs preprocessing techniques such as normalization, augmentation, and transformation to prepare the data in desired format. 2. Multi-Model Embedding Engine: The system utilizes various embedding models to convert diverse sources of inputs into high-dimensional vectors that capture semantic meaning in a unified embedding space. 3. Large Language Model Core: The system integrates the unified embeddings from different data types into a cohesive representation. The model core of embodiments leverages multi-head attention mechanisms to weigh and/or combine the data.

Enterprise data is often unstructured, spanning cross multiple modalities. For example, a PDF file might contain a mixture of text, tables, charts, and images. Addressing the challenges posed by such heterogeneous data requires a robust strategy for handling and integrating diverse data types. There are several challenges to consider when working with multimodal data sources such as how to ensure each type of data is processed properly with minimal information loss or how to merge and align information across different modalities into a coherent and unified representation.

In an embodiment, a data ingestion system including an integrated data ingestion framework capable of handling different data modalities includes the following components:

Input Identification and Categorization Modules: Input files are identified and categorized based on its formats. Both parser-based and model-based techniques are employed by these modules to identify and extract text, tables, graphs, and charts from the source file.

Contextual Content Processing Modules: These modules deploy an advanced chunking strategy that segments the input contextual contents, tailored to input context lengths. This ensures the data is processed in manageable and relevant segments.

Images Handling modules: The framework leverages a fine-tuned multimodal large language model (MLLM) to generate descriptions and summaries of extracted images from the source file. A multimodal large language model (MLLM) is leveraged to generate descriptions and summaries of the extracted images.

Table Processing modules: Model-based table recognition techniques are applied to convert tabular data into structured formats.

Feature Integration modules: Features extracted from different modalities are converted into a unified contextual representation. This ensure all data is harmonized for further retrieval and generation. A knowledge graph is then constructed to represent the relationships between different data elements, providing a structured and interconnected view of the ingested data.

Multimodal Data Ingestion Modules: The proposed invention is a robust multimodal data ingestion framework designed to leverage powerful large language models to effectively ingest, process, and interpret multi-model data sources. The example frameworks consist of at least some of the following components:
1. Data Ingestion Layer: It enables the control of data flow from cloud to edge device in a range of formats, including text documents, images, structured data (e.g., tables and databases), and unstructured data (e.g., graphs and diagrams). In addition, it supports various preprocessing techniques such as normalization, augmentation, and transformation to prepare the data in desired format. The framework introduces data augmentation and normalization methods that are specifically designed to optimize the preparation of diverse data types. These techniques involve dynamically adjusting augmentation strategies based on the data's modality and context, enhancing the overall quality and consistency of the ingested data.
2. Multimodal Embedding Engine: The system utilized vector embedding models to convert diverse sources of inputs into high-dimensional vectors that capture semantic meaning in a unified embedding space. The system improves traditional methods by converting and unifying various data types into a single cohesive representation. This process leverages cross-modal embedding techniques that preserve the semantic integrity of the data while ensuring compatibility across different modalities. Unlike traditional solutions, this method supports dynamic adjustments based on the characteristics of the input data, allowing for seamless integration.

The Multimodal Embedding Engine converts diverse input sources into high-dimensional vectors that capture the semantic meaning within a unified embedding space. This step is critical for ensuring that the data from different modalities can be effectively integrated and processed by the large language model core.
3. Large Language Model Core: The system integrates the unified embeddings from different data types into a cohesive representation. It leverage multi-head attention mechanisms to weigh and combine information from various modalities. Fined-tuned large language models are used to understand and generate contextually relevant responses. This enhances the ability of a thought/action agent service to process, understand, and generate responses from a wide range of data types, including text, images, tables, graphs, charts, and diagrams. This framework leverages the advanced capability of large language models to seamlessly integrate and interpret multimodal data, significantly improving the versatility and utility of RAG systems.

Example large language models suitable for the example framework are specially fine-tuned for multimodal data processing, including Phi3-3-vision-128k-instruct and Chameleon. This fine-tuning process involves training the models on a diverse set of multimodal data, enabling them to accurately interpret and generate responses that consider the relationships between different data types. The fine-tuning significantly enhances the model's contextual understanding and summarization capabilities, particularly in scenarios involving complex or heterogeneous data sets.

The system includes a robust multimodal data ingestion framework designed to leverage powerful large language models to effectively ingest, process, and interpret multi-model data sources. The system uses a specially fine-tuned large language model uniquely adapted for multimodal data processing. The fine-tuning significantly improves the model's contextual understanding and summarization capabilities. The multimodal data ingestion system efficiently processes and integrates a variety of data types, such as text, images, and structured data. This capability significantly broadens the applicability of RAG systems across different domains and use cases. The system framework incorporates advanced embedding and preprocessing techniques, which lead to more accurate data interpretation and response generation. The modular design ensures easy scalability, allowing the system to handle large volumes of data and complex multimodal data. This flexibility makes the framework suitable for both small-scale applications, and enterprise-level deployments.

### 6. Machine Learning Architecture

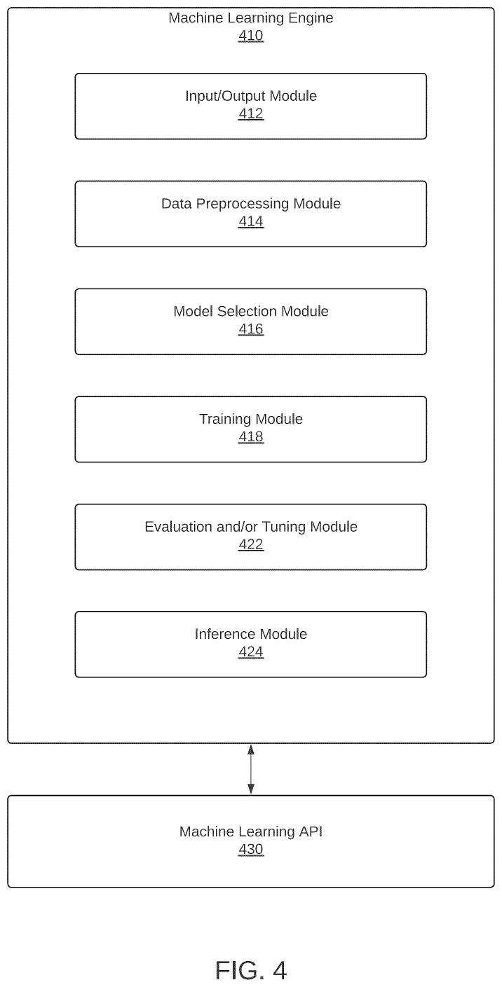

FIG. 4 illustrates a machine learning engine 400 in accordance with one or more embodiments. As illustrated in FIG. 4, machine learning engine 400 includes input/output module 420, data preprocessing module 414, model selection module 416, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 414 transforms data into a format suitable for use by other modules in machine learning engine 400. For example, data preprocessing module 414 may transform raw data into a normalized or standardized format suitable for training ML models and for processing new data inputs for inference. In an embodiment, data preprocessing module 414 acts as a bridge between the raw data sources and the analytical capabilities of machine learning engine 400.

In an embodiment, data preprocessing module 414 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 414 may be configured to handle anomalies in different ways depending on context. Data preprocessing module 414 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 414 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 414 processes new data for inference, data preprocessing module 414 replicates the same preprocessing steps to ensure consistency with the training data format. This helps to avoid discrepancies between the training data format and the inference data format, thereby reducing the likelihood of inaccurate or invalid model predictions.

In an embodiment, model selection module 416 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 416 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 416 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 416 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 416 also considers computational efficiency and resource constraints. This is meant to help ensure the selected model is both accurate and practical in terms of computational and time requirements. In an embodiment, certain features of model selection module 416 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

### 7. Machine Learning Operations

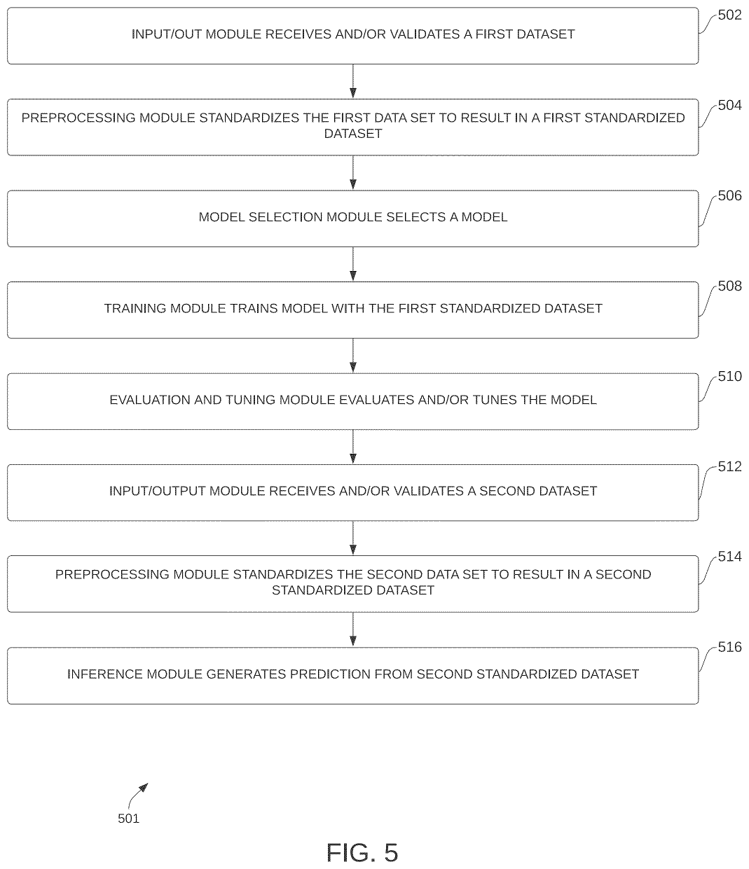

FIG. 5 illustrates a set of machine learning operations 500. In embodiments, one or more operations of the set of operations 500 is performed by a machine learning engine such as machine learning engine 400. In an embodiment, input/output module 420 receives a dataset intended for training (Operation 502). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 414. Here, the data undergoes a series of transformations to standardize and clean it, making it suitable for training ML models (Operation 504). This involves normalizing numerical data, encoding categorical variables, and handling missing values through techniques like imputation.

In an embodiment, prepared data from the data preprocessing module 414 is then fed into model selection module 416 (Operation 506). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 508). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 510). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 512).

In an embodiment, data preprocessing module 414 receives the validated dataset intended for inference (Operation 514). Data preprocessing module 414 ensures that the data format used in training is replicated for the new inference data, maintaining consistency and accuracy for the model's predictions.

In an embodiment, inference module 430 processes the new data set intended for inference, using the trained and tuned model (Operation 516). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 8. Generative Artificial Intelligence Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a “SoftMax” function to obtain the weights for the value vectors. A “SoftMax” function, or normalized exponential function, converts a vector of real numbers into a probability distribution of possible outcomes. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 412, when used for large language models, handles textual data, converting input text into a format that the model can process. The text is broken down into tokens, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 414 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 416, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 418, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 422 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 424, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data, encoding inputs into a latent space and generating outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 9. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (“NAT”). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a taxonomic negative sampling-based machine learning system via a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users with the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users with the capability to provision processing, storage, networks, and other fundamental computing resources provided by the network resources. Any arbitrary applications, including an operating system, may be deployed on the network resources.

In an embodiment, various deployment versions of a taxonomic negative sampling-based machine learning system may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network. ” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 10. Microservice Applications

According to one or more embodiments, the techniques described herein are implemented in a microservice architecture. A microservice in this context refers to software logic designed to be independently deployable, having endpoints that may be logically coupled to other microservices to build a variety of applications, for example, by logically coupling a taxonomic negative sampling-based machine learning system to a software logic endpoint. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 11. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

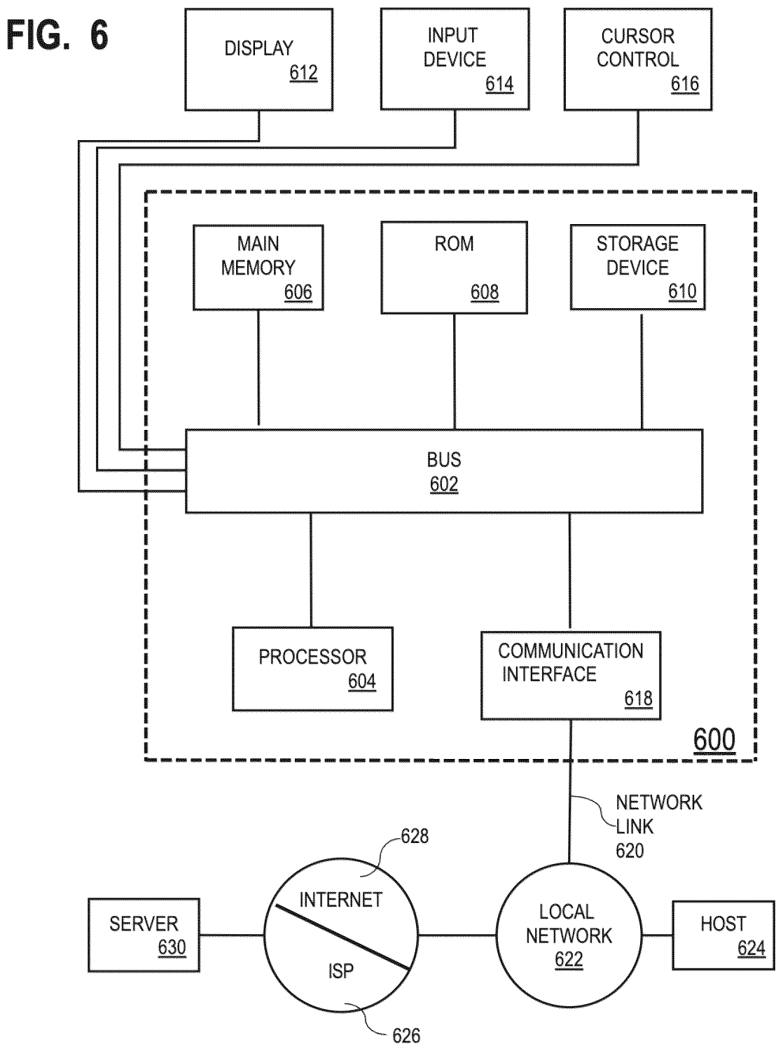

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 12. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
accessing a document containing a text portion and a non-text portion;
identifying a type of the non-text portion;
generating, using a first multimodal model configured for the type of the non-text portion, a first text corpus corresponding to the non-text portion; and
generating a cross-modal embedding of the document, the cross-modal embedding comprising a vector representation of the first text corpus and the non-text portion; and
storing the cross-modal embedding in a vector database;
wherein the method is performed by at least one device including a hardware processor.

2. The method of claim 1, further comprising:
accessing a second document containing a second text portion, a graphic data representation of a first type, and an image;
generating, using a first language model, a second text corpus corresponding to the second text portion;
generating, using a second multimodal model configured for the first type of graphic data representation, a second text corpus describing information contained in the graphic data representation;
generating, using a third multimodal model configured for images, a fourth text corpus corresponding to contents of the image; and
generating a cross-modal embedding of the second text corpus, the graphic data representation, the fourth text corpus, and the image.

3. The method of claim 2, wherein:
the first type of graphic data representation comprises at least one of: a graph, a chart, a table, a plot, a diagram, a frequency distribution, a histogram, a pictograph, and a knowledge graph.

4. The method of claim 1, wherein:
the non-text portion comprises a graphic data representation;
the method further comprising:
generating the first text corpus by extracting, from the graphic data representation, at least one of: a title text, an axis label text, a body text, a caption text, and a data point value.

5. The method of claim 1, further comprising:
extracting a data point from the non-text portion using a data point extraction model;
collecting feedback for an answer generated based on the document being retrieved from the vector database using a cross-modal embedding of the data point; and
fine-tuning the data point extraction model by providing the feedback as training data to the data point extraction model.

6. The method of claim 1, further comprising:
collecting feedback for an answer generated based on the document being retrieved from the vector database using the cross-modal embedding; and
fine-tuning the first multimodal model using multi-head attention by providing the feedback as training data to the first multimodal model.

7. The method of claim 1, wherein:
the non-text portion comprises a graphic data representation;
the method further comprising:
generating the first text corpus by:
extracting a data point from the graphic data representation; and
summarizing the data point using one or more models configured to:
extract one or more values corresponding to the data point; and
extract one or more labels corresponding to the values; and
including one or more descriptions of the one or more values and the one or more labels in the first text corpus.

8. The method of claim 1, wherein:
generating the first text corpus comprises:
extracting a text component corresponding to the non-text portion from the text portion based on the text component referencing the non-text portion; and
generating the cross-modal embedding comprises generating a vector representation of the text component, the first text corpus and the non-text portion.

9. The method of claim 1, further comprising:
extracting the first text corpus from an image contained in the non-text portion;
extracting a second text corpus from a graphic data representation contained in the non-text portion; and
applying a first weighting to the first text corpus and a second weighting to the second text corpus; wherein
the cross-modal embedding comprises a vector representation of the first text corpus, the second text corpus, the image, and the graphic data representation.

10. The method of claim 1, wherein:
the document comprises a first document chunk including the text portion and a second document chunk including the non-text portion; and
first text corpus comprises a textual description of the non-text portion;
the method further comprising:
accessing a query;
identifying the first document chunk based on a semantic similarity between the text portion and the query;
identifying the second document chunk based on a vector search using the query to identify the cross-modal embedding; and
generating a response to the query based on the first document chunk and the second document chunk.

11. The method of claim 1, wherein:
the document comprises a text portion, a graphic data representation, and an image;
the method further comprising:
chunking the document into a first chunk comprising the text portion, a second chunk comprising the graphic data representation, and a third chunk comprising the image.

12. One or more non-transitory computer readable media comprising instructions which, when executed by one or more hardware processors, cause performance of operations comprising:
accessing a document containing a text portion and a non-text portion;
identifying a type of the non-text portion;
generating, using a first multimodal model configured for the type of the non-text portion, a first text corpus corresponding to the non-text portion; and
generating a cross-modal embedding of the document, the cross-modal embedding comprising a vector representation of the first text corpus and the non-text portion, by:
extracting a first feature of the text portion;
extracting a second feature of the non-text portion; and
flattening the first feature and the second feature into the vector representation; and
storing the cross-modal embedding in a vector database.

13. The non-transitory computer readable media of claim 12, the operations further comprising:
accessing a second document containing a second text portion, a graphic data representation of a first type, and an image;
generating, using a first language model, a second text corpus corresponding to the second text portion;
generating, using a second multimodal model configured for the first type of graphic data representation, a second text corpus describing information contained in the graphic data representation;
generating, using a third multimodal model configured for images, a fourth text corpus corresponding to contents of the image; and
generating a cross-modal embedding of the second text corpus, the graphic data representation, the fourth text corpus, and the image, wherein the first type of graphic data representation comprises at least one of: a graph, a chart, a table, a plot, a diagram, a frequency distribution, a histogram, a pictograph, and a knowledge graph.

14. The non-transitory computer readable media of claim 13, wherein:
the non-text portion comprises a graphic data representation;
the operations further comprising:
generating the first text corpus by extracting, from the graphic data representation, at least one of: a title text, an axis label text, a body text, a caption text, and a data point value.

15. The non-transitory computer readable media of claim 12, the operations further comprising:
extracting a data point from the non-text portion using a data point extraction model;
collecting feedback for an answer generated based on the document being retrieved from the vector database using a cross-modal embedding of the data point; and
fine-tuning the data point extraction model by providing the feedback as training data to the data point extraction model.

16. The non-transitory computer readable media of claim 12, the operations further comprising:
collecting feedback for an answer generated based on the document being retrieved from the vector database using the cross-modal embedding; and
fine-tuning the first multimodal model using multi-head attention by providing the feedback as training data to the first multimodal model.

17. A system, comprising:
at least one device including a hardware processor;
the system being configured to perform operations comprising:
accessing a document containing a text portion and a non-text portion;
identifying a type of the non-text portion;
generating, using a first multimodal model configured for the type of the non-text portion, a first text corpus corresponding to the non-text portion; and
generating a cross-modal embedding of the document, the cross-modal embedding comprising a vector representation of the first text corpus and the non-text portion; and
storing the cross-modal embedding in a vector database.

18. The system of claim 17, the operations further comprising:
accessing a second document containing a second text portion, a graphic data representation of a first type, and an image;
generating, using a first language model, a second text corpus corresponding to the second text portion;
generating, using a second multimodal model configured for the first type of graphic data representation, a second text corpus describing information contained in the graphic data representation;
generating, using a third multimodal model configured for images, a fourth text corpus corresponding to contents of the image; and
generating a cross-modal embedding of the second text corpus, the graphic data representation, the fourth text corpus, and the image, wherein the first type of graphic data representation comprises at least one of: a graph, a chart, a table, a plot, a diagram, a frequency distribution, a histogram, a pictograph, and a knowledge graph.

19. The system of claim 18, wherein:
the non-text portion comprises a graphic data representation;
the operations further comprising:
generating the first text corpus by extracting, from the graphic data representation, at least one of: a title text, an axis label text, a body text, a caption text, and a data point value.

20. The system of claim 17, the operations further comprising:
extracting a data point from the non-text portion using a data point extraction model;
collecting first feedback for an answer generated based on the document being retrieved from the vector database using a cross-modal embedding of the data point;
fine-tuning the data point extraction model by providing the first feedback as training data to the data point extraction model
collecting second feedback for an answer generated based on the document being retrieved from the vector database using the cross-modal embedding; and
fine-tuning the first multimodal model using multi-head attention by providing the second feedback as training data to the first multimodal model.
